(19) United States
(12) Patent Application Publication
(10) Pub. No.: US 2007/0262879 A1
(43) Pub. Date: Nov. 15, 2007

(54) I/O bus for analog sensors in an IC

(76) Inventors: Robert Greiner, Beaverton, OR (US); Edward Burton, Hillsboro, OR (US); Anant Deval, Beaverton, OR (US); Doug Huard, Portland, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/432,869

(22) Filed: May 12, 2006

(51) Int. Cl. G08C 19/16

(52) U.S. Cl. 340/870.21

(57) ABSTRACT

An input/output bus for analog sensors in an integrated circuit is described. In one example, a plurality of analog sensors generate an analog output in response to a respective event on the integrated circuit. A plurality of digitizers each coupled to an analog sensor generate a digital representation of the analog output of the respective sensor, and a communications bus coupled to the plurality of digitizers communicates the digital representations to an external device.

### FIELD

The present description relates to the field of test and analysis of integrated circuit devices, and, in particular, to carrying a wide range of digitized sensor data on a common bus.

### BACKGROUND

With a very complex electronic or logic device there are a great many different states and conditions that the device may enter. In order to quickly and reliably test, troubleshoot and debug such a device, the states must be known with accuracy and certainty.

It is first very difficult to acquire a large amount of information from a complex device and second difficult to acquire the information in a reliable, reproducible form. Many desired states and conditions are analog states and conditions such as temperature, voltage, current, and timing. These analog states and conditions are generally sensed by analog sensors, and converted into some digital form to be processed by internal logic.

The analysis, troubleshooting and debugging of complex digital ICs (Integrated Circuits), such as microprocessors often involves collecting data about the operational status and actual operations of the IC upon the electrical observation of a suspected bug. This data collection generally includes a large amount of information about initial internal states at some time before the suspected bug occurs, and all available external data supplied to the IC between the initial state and when the bug occurs. A set of collected data associated with the time at which it is collected is sometimes referred to as an input data vector. The entire data collection, that is the initial internal state plus the input data vector is sometimes referred to as a trace. In this case “data” refers to any input signals.

Once a bug-related trace has been collected, the trace can be used in a logic simulator, a high speed computer and program that simulate the behavior of the IC. This can provide the initial conditions for the bug and a model of what stimulated the bug. Once the simulation has successfully generated the same bug observed in the IC, the trace containing the bug is transported into a stored-response tester.

The trace will normally include some data collected from analog sensors on the IC. Analog sensors present a challenge in stored-response testers, since it is may be difficult or impossible to reproduce an analog data vector by simply recreating the same analog environmental conditions. An analog sensor will tend to produce small differences in its sensed result, each time the same process is performed in the IC. In other words, analog sensors are generally not deterministic, and stored-response testers generally require determinism.

### BRIEF DESCRIPTION OF THE DRAWINGS

Embodiments of the present invention will be understood more fully from the detailed description given below and from the accompanying drawings of various embodiments of the invention. The drawings, however, should not be taken to be limiting, but are for explanation and understanding only.

FIG. 1 is a block diagram of a device under test in a test environment according to an embodiment of the invention;

FIG. 2 is a block diagram of the device under test of FIG. 1 showing an analog sensor bus and an external communications bus according to an embodiment of the invention;

FIG. 3 is a block diagram of the device under test of FIG. 1 showing time synchronization and combinatorial logic according to an embodiment of the invention;

FIG. 4 is a process flow diagram of testing the device under test of FIG. 1 according to an embodiment of the invention;

FIG. 5 is another process flow diagram of testing the device under test of FIG. 1 according to an embodiment of the invention; and

FIG. 6 is a block diagram of a computer system suitable for use with the device under test of FIG. 1 and other described hardware.

### DETAILED DESCRIPTION

In one embodiment of the invention, the outputs of analog sensors in an IC may be digitized and sent in a digital form on a common bus to external components for analysis as well as to internal components for a variety of uses. Since the output of each analog sensor is communicated externally, it can be readily collected to create a data vector that can then be used to create a trace. Using data collected from the common bus, the collected traces may include both an initial internal state of the IC and a complete data vector (including the analog portion of the data vector). This may improve the ability to properly logically simulate the one trace, and hence reproduce its entire flow of internal state versus time. Such a detailed simulation may provide enough detail to track down a bug without recreating the bug on a stored response tester.

The collected analog sensor data may also be used to observe the operating environment of the IC continuously while the IC is operating. This can provide a wealth of useful engineering data. In addition, the digitized output of each sensor provides both a check of the accuracy of the sensors and an opportunity to gather data for use in electrically trimming each sensor. This may be done by operating the IC under controlled conditions, such as a particular temperature, voltage, load, or frequency. The output of the analog sensor may then be checked against the known condition.

In another embodiment of the invention, the common bus that is used to communicate digitized analog data to the outside world, may also be used to input surrogate analog data into the integrated circuit. The surrogate data may be consumed by the IC just as if the data was digitized analog data from the analog sensors. The surrogate data can come from any number of sources, such as external testers.

A bug trace gathered from a tested IC in operation can be run on a stored response tester. The stored-response tester generally can solve the bug much more readily. The surrogate data allows, a Device Under Test (DUT) to then be exposed to a stored version of the same analog (and digital) data vector that comprised the original bug trace. The outputs from the common bus may then be collected to observe the behavior of the IC. The surrogate data also allows a bug trace to easily be run on many different DUTs to see if they all exhibit the same bug.

With the common bus carrying digitized sensor information, a set of outputs may be compared with previous values. These exact values may be used in debug tools to compare with simulated data. For testing purposes, when the bus is used to supply digitized surrogate data to a large number of devices, a set of input stimuli may be precisely defined along with the initial conditions for a variety of different tests. Known, well-defined initial conditions plus well-defined stimulus data render any resulting test to be deterministic. While deterministic behavior is of great value in debugging complex electronic devices, the sensors often used for debugging are analog and inherently non-deterministic.

The logic simulator may be able to deterministically produce a logic trace of many of the internal logic states inside the IC using data that is externally visible at the pins of the IC. Including the digitized analog information from the IC in this externally visible data may allow the behavior of the IC to be predicted deterministically. The simulated trace that is based on deterministic behavior may be used to successfully debug a complex IC. Without the deterministic behavior trace, bugs may be impossible to accurately identify.

In addition, in order to exercise or test a part, a predetermined flow of analog data may be generated in a tester. This data may be based on a captured trace from the device or on simulations or analysis. The common bus may be used to supply surrogate analog data to the IC as an input. The supplied data allows the IC to be exercised under a specific set of conditions and its response may be measured again by capturing a new trace based on the digitized analog data.

In high volume manufacturing, for example, the surrogate data may be used to fully test the logic consuming all the surrogate analog sensory information. Since the tester can easily provide any “analog” data over the entire range allowed by the consuming logic, this testing can include testing of analog states that would normally be illegal or even unsafe. For example, the thermal shutdown logic may be tested to ensure that the IC will shut down if it overheats without actually overheating the IC.

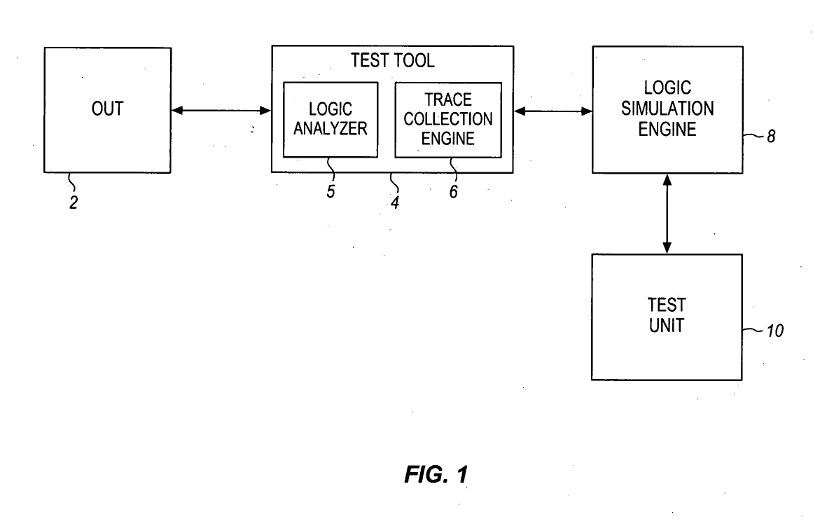

Referring to FIG. 1, a complex electronic or logic device is identified as a DUT (device under test) 2. In one example, the DUT is a microprocessor installed into a socket on a test board (not shown) for test purposes. The test board may include power supply, thermal control, I/O throughput and other functions for the DUT. The test board may also be a production motherboard or a test or development motherboard for an electronic system, such as a computer. The DUT is coupled to an external test tool 4 that includes a logic analyzer 6, and a trace collection engine 7.

The DUT may be coupled through a special debug connector on the motherboard that is coupled to socket pins, through a special interface on the IC or through specific socket pins. It may also be coupled through the socket so that all of the pins or all of the command, control and data pins are coupled to the test tool. Alternatively, the DUT may be coupled to the test tool only through a special debug port.

The logic analyzer looks at the data that is going into and out of the DUT. As explained in more detail below, with information about the timing of the data on the bus between the DUT and the test tool, the logic analyzer may determine the source for all of the information received from the DUT and associate it with the appropriate timing and other signals, such as I/O signals and logic states. The trace collection engine collects traces corresponding to different time sequences or different time intervals. The connection to the communications bus between the DUT and the test tool may be used to allow the test tool to see every signal that may be produced on any pin of the DUT and the trace collection engine allows this information to be collected and recorded.

The test tool is coupled to a logic simulation engine 8. The logic simulation engine receives traces from the trace collection engine that may be used to simulate the behavior of the logic in the IC. This may be used to predict later outputs or later trace collections based on assumptions about environmental conditions and process conditions. The results from the logic simulation engine may be compared to the results from the actual DUT for debugging and other analysis purposes.

The logic simulation engine is coupled to a test unit to generate tests, accumulate results, and provide scores. The test unit may also be coupled to a user or operator interface, debugging software, inventory tracking, system management or other control devices. For simplicity and ease of understanding, the test system of FIG. 1 is shown as including only four different devices and applying to only one DUT. However, the test system may include many DUTs and many more components that participate in or operate a variety of different tests.

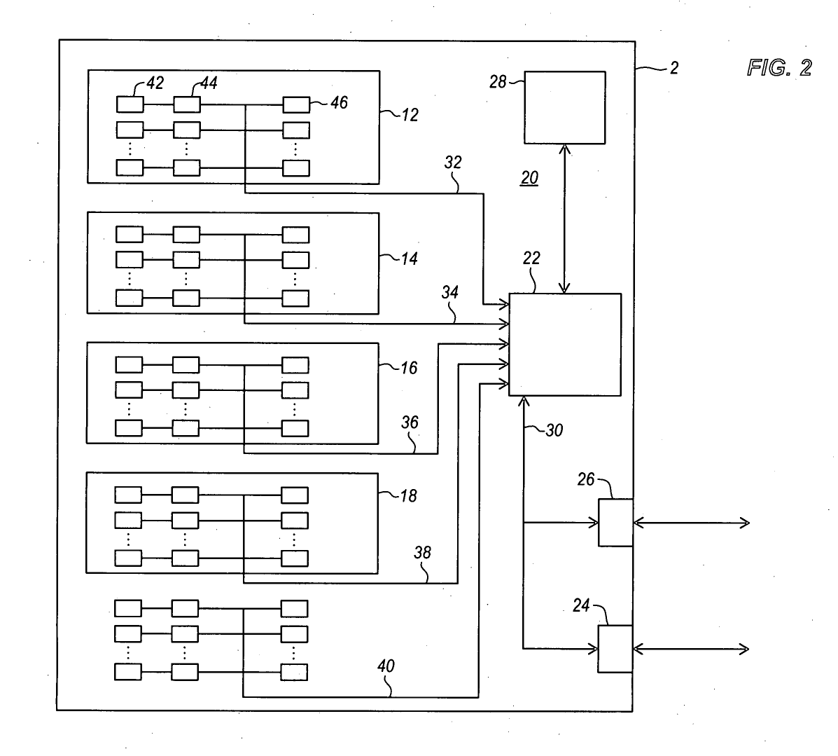

FIG. 2 shows the DUT 2 in more detail. In the example of FIG. 2, the DUT is a microprocessor with four processing cores 12, 14, 16, 18 and an global control block 20. Any number of cores, including one core may be used. The IC may or may not have a global control block. In the example of FIG. 2, the global control block contains shared resources for the processing cores and may also contain any of a variety of other components.

In the present example, in addition to other components (not shown) the global control block includes an external bus control unit 22 that collects a sensor output bus 32, 34, 36, 38 from each processing core and a sensor output bus 40 from the global control block. The external bus control unit accumulates the data from each bus, using for example a serializer/deserializer and applies it to a single external communications bus 30.

The communications bus 30 may be coupled to external interfaces 24, 26 that transmit the bus data to external devices, such as a test tool 4 using the same protocol as the communications bus or a different protocol. The communications bus may also be coupled to internal devices 28 within the global control block 20.

The external bus control unit may combine the data from each analog sensor bus together in a simple way or it may apply any level of logic or processing to the data. For example, a simple bus control unit may have a sequence of staged OR gates. A more complex bus control unit may have buffers to collect the data from the analog sensor buses, order the data, and apply timing to them. A still more complex control unit may translate the sensor bus data, apply timestamps or headers or other additional data or metadata to the sensor bus data.

Each processing core contains analog sensors 42. The sensors are each coupled to their own digitizer 44 that converts the sensed analog value to a digital representation of that value and applies the digital representation to the connected analog sensor bus 32,34, 36, 38. As shown in FIG. 2, the analog sensors number 1-n for each processing core. In other words, there may be any number of sensors, typically dozens of sensors, however, more or fewer may be used.

In addition to the sensors, consumers 46 are also coupled to the analog sensor bus. The consumers receive data from the bus in a digital form and then apply the digital value to a status register, buffer, or signal input for a connected component within the core. The consumers may be used to drive the IC to a particular known state. This may be very helpful in diagnostic testing to isolate conditions that may otherwise be difficult to control.

Similarly, as also shown in FIG. 2, the global control block also contains any number of analog sensors coupled to the global control block's analog sensor bus 40 through a digitizer. Consumers are coupled to the global control block bus as well allowing for a full range of detection and testing to be applied to the global control block in the same way that it is applied to the processing cores.

The analog sensors may include any of a variety of different types of sensors, such as voltage sensors, current sensors, temperature sensors, and various activity sensors. In some cases, the sensors may detect an analog value with a wide range of different possible values, in other cases, the analog sensor may detect a high or low state on a single signal line or pin. If the signal line or pin is capable of three or four states, then the analog sensor may be capable of detecting all three or four states.

An analog sensor may be used, for example to detect the presence of a synchronization lock signal on a timing circuit. A phase lock loop (PLL) circuit, for example, may have a signal line to indicate when it has obtained a lock. This may be used to indicate to other devices on the IC that they may begin using the signal. Such a single signal may be digitized for the analog sensor bus.

Similarly, the IC may have a series of signal lines to indicate that stable power is being received (PWRGOOD, PWROK, etc.). The output of these or any other signal line may be digitized and placed on the analog sensor bus. While sensor outputs may be simple or complex, placing a great variety of different sensor outputs on the same bus allows them to be collected with a single set of tools and with internal consistency.

Similarly the consumers 46 may be used to allow the test tool to simulate or set similar conditions. Rather than allow a PLL to set the lock signal when it detects a lock. A consumer may be used to set the lock signal at a specific time, so that the impact of the lock signal on downstream circuits may be more precisely observed. Similarly, the timing of a PWRGOOD, or PWROK signal may be controlled.

In another example, the analog sensor may be a temperature, voltage, or current sensor. In one example, a temperature sensor may be used to determine when a core is becoming overheated and then, through a thermal control circuit, the voltage may be reduced to reduce the temperature of the core. The analog temperature sensor on the output bus may be monitored over time by the test tool and the resulting change in voltage may also be monitored by the test tool monitoring a voltage sensor for the core. In this way, the proper functioning of the thermal control circuit may be confirmed.

Using a consumer at the temperature sensor, a high temperature, selected by the test tool may be simulated by sending a selected temperature value to the corresponding register. As a result, regardless of the actual sensed temperature, the thermal control circuit will receive the simulated temperature value. The corresponding adjustment in voltage may be monitored again by the test tool. By pushing simulated values from the test tool to the DUT, a variety of very well-defined circumstances may be tested quickly and accurately. Such a test may also look at clock or bus frequencies, currents or any other parameters that may be used by the thermal control system.

In another example, a voltage sensor may be coupled to a voltage regulator loop for the DUT. In this loop, if the voltage is too low, the voltage regulator tries to increase it and if the voltage is too high, then the voltage regulator tries to decrease it. The test tool may monitor the behavior of the circuit by receiving the digitized analog voltage value through the communications bus. The performance of the voltage regulator may be very quickly checked using the architecture if FIG. 2, by breaking the connection between the voltage sensor and the voltage regulator.

Using the bidirectional analog sensor bus 32, the digitized voltage measurement may be received at the test tool. A different digitized voltage value may be sent from the test tool to the voltage sensor consumer, for example a register accessible to and used by the voltage regulator. The voltage regulator may then be informed that there is an under-voltage at the core and raise the voltage accordingly. The increased voltage may be monitored by the test tool. This may be done even if the actual voltage was within bounds. The thermal control test may be performed in a similar way by breaking the connection between the sensor and the consumer of the sensed value.

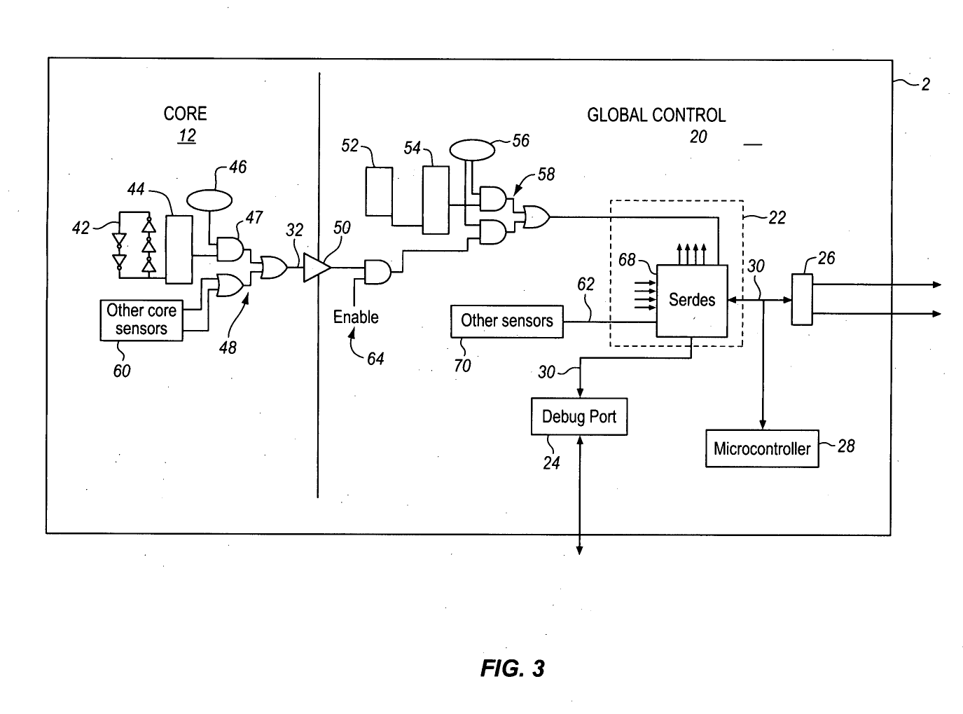

FIG. 3 shows the DUT 2 of FIG. 1 from another perspective. In FIG. 3, only a single processing core 12 and a global control block 20 are shown. However, as in the example of FIG. 2, any number of cores may be used. In the processing core 12, a first sensor 42 is shown in the form of a hot ring oscillator that may be used to sample voltage on a signal line without significantly affecting the sampled voltage. Such an A/D (Analog to Digital) converter may be formed from a free running ring oscillator feeding a 16 bit gray-code counter 44. However, other types of sensors and digitizers may be used instead.

Using gray-code, bit errors have only a minor impact, since only one bit changes per count. The value sent to the external bus controller may also affect the sensor's and the digitizer's sensitivity to errors. Using, for example, a 10 or less-bit value may reduce error sensitivity. For such an analog sensor, accuracy may be improved through calibration. The actual oscillation frequency may be affected not only by voltage, but also by temperature, variations in the manufacturing process, and the age of the sensor. The sensor may be calibrated at the factory and then correction factors may be stored as fuse bits. The hot ring oscillator is provided only as an example, such a calibration approach may be applied to a variety of different sensor types. The sample size, frequency and dynamic range of the sensor may be selected to suit any particular application.

In addition to the analog sensor and the digitizer, FIG. 2 shows a time slot scheduler 46 between the digitizer and the analog sensor bus. The time slot scheduler may be a part of the digitizer, as shown in FIG. 2, or a separate component. The time slot scheduler operates an enable input to an AND gate that is used to allow the digitized representation of the analog value to be applied to the analog sensor bus 32 at an assigned time. In one embodiment, a specific time interval is assigned to each analog sensor. The digitized representation of the analog sensor output is to be applied to the analog sensor bus during that time. The timing can be aligned with the IC or processor core timing or with any other reference. This allows the digitized representations to be applied to the bus without benefit of any header or other identifier other than the timing.

The digitized representations of the analog sensor data may be retrieved by the logic analyzer if the logic knows the sequence. Such a bus virtually eliminates all overhead except for a small guard time between assigned time intervals. The time slot scheduler has knowledge of the timing assignment and ensures that the digitized representation of the analog value is applied to the bus during the assigned timing interval by operating the AND gate accordingly.

The timing assignments may be determined before the chip is fabricated and hard coded into the circuitry of each time slot scheduler. Alternatively, fuse bits may be used to program in the scheduled times after the IC is produced. For maximum flexibility, settable addressable registers in each time slot scheduler may be used. The time slot schedulers may be configured in any way that may be considered appropriate for a particular application. The schedulers may also be programmed with different reporting frequencies. In other words, some values may be reported on the bus more frequently than other values. In this way, values that change frequently or that are more time sensitive may be tracked more often than values that change rarely or only once.

In one embodiment, the time slot scheduler has a counter and receives the system clock. Each time the clock counts up to the counter register value, the enable signal is produced to apply the digital voltage value to the sensor bus. Alternatively a comparator may be used to compare a specific number of the least significant bits of the clock value to the register value. In this way every other, every fourth, every eighth etc. clock pulse will cause the enable signal to be produced. A variety of other approaches may be used depending on the intended application.

Using the time slot synchronizer, the bus may be operated without any additional overhead for time stamps. Each digitized analog sensor value is reported at a particular assigned time. The bus as shown in the figures is configured so that each value will propagate to the external bus control unit in about the same amount of time each time the value is reported. In addition, the ordering of all of the time slot schedulers is the same for each cycle. This allows the logic analyzer to determine the time at which an analog sensor value was measured by subtracting the propagation delay. In addition, the logic analyzer is able to correlate each value on the bus to a particular analog sensor using the known order of reporting. For greater certainty, the external bus control unit or one or more time slot schedulers may add time stamps to the data stream.

In another embodiment, the analog sensor bus may be a random access bus that receives data packets from each node at no particular time or within some range of possible times. For such an analog sensor bus, rather than timing, a header may be used to unambiguously identify the sender. The time slot scheduler may apply appropriate headers in addition to attending to any timing needs for the system. Such headers may also include a time stamp.

FIG. 3 also shows that the processing core may have additional sensors 60 that are coupled to the analog sensor output bus 32. While a voltage sensor is shown in detail, the other sensors may include voltage sensors as well as any of the other sensors mentioned above, including temperature, current, and status sensors. Additional logic 48, for example one or more OR gates, may be used to combine the application of all of the digital outputs from the processing core onto the bus. An OR gate will allow all of the sensor outputs to be passed onto the bus. Alternatively XOR gates may be used to prevent time collisions or more complex combining devices may be used to retime, synchronize, amplify or apply other processes to the signals.

Between the processing core and the global control block, the signals on the analog sensor bus may be amplified in a level shifter 50 or processed in any of a variety of other ways by repeaters, impedance matching circuits, etc. The signals are then applied to a single AND gate with an enable block 64 as its other input. The enable block may be used to connect and disconnect the sensor bus from the global control block. In one example, the enable block is used to disconnect the bus whenever the corresponding core is powered down, on standby or in a special state or routine. In another embodiment, the enable block may be used to provide a timing cycle so that each core has access to the external bus control block 22 at different times. The enable blocks for each core may be operated in a round robin fashion so that each core takes a turn.

As shown in FIG. 3, the global control block 20 also may have analog sensors 52 (only one is shown) coupled to a digitizer 54 and a time slot scheduler 56. The outputs from these sensors may be combined with the digitized analog signals on the core's sensor bus in the global control block. The core signals and global control block signals may be combined in a variety of different ways. In one example in FIG. 3, groups of AND and OR gates 58 are used. The particular arrangement of logic gates may be modified to suit any particular application. In the present example, the signals from the processing core are AND'ed with a time slot scheduler that coordinates the timing of the core sensor data with the global control block sensor data. The output of this AND gate is then AND'ed with the global control block sensor 52, 54 output.

In another example, sensors 70 on the global control block 20 are combined onto a specific analog sensor bus 62 for the global control block. The data is then passed into the external bus control circuit 22.

Similar to FIG. 2, FIG. 3 shows that the external bus control circuit 22 has outputs to two external output ports 24, 26 and to internal processes 28. In the present example, the first external port 24 is a debug port. The interface converts the sensor bus data to a format suitable for the test tool. This may be a high speed serial bus or a multiple pin bus. The specific design of the bus may be adapted to suit any particular application. The other external port may be coupled to any of a variety of other devices, for example it may be coupled to a voltage regulator, power gate control or other power supply or timing supply, or thermal control system. Through these external devices, the sensor data on the communications bus may be used during normal operation to control voltage, power, temperature or other parameters of the IC in operation.

The internal port 28 is indicated as being a microcontroller. The microcontroller in the global control block may use the information in the bus in any of a variety of different ways. The information may be used in test operations and also in normal operation. The microcontroller may implement a variety of high level algorithms in firmware or software. Such algorithms may include power control, including standby, hibernation and wait states, thermal control, frequency and voltage control and signaling analysis. The microcontroller has control and output lines (not shown) to a variety of other devices to implement any such algorithms or other algorithms. In addition, another analog sensor bus (not shown) may be coupled to sensors and consumers within the microcontroller.

Within the external bus control unit 22, there may be further timing circuits further numeric conversion circuits and other components as may be desired for a particular application. In particular, if there are additional cores or control blocks that have sensor buses coupled to the bus control unit, then these sensor bus inputs may be applied to a serializer/deserializer 68 to combine all of the data into a single serial data stream. The serializer/deserializer may have multiple inputs, one or more for each input bus and multiple outputs, one for each data receiver. In FIG. 3, there are three outputs and four inputs shown, however, this is provided as an example only. The number of inputs and outputs may be adapted to suit any particular application.

The serializer/deserializer may use any of a variety of different approaches with different complexity to apply all of the sensor bus data to the communication bus 30. In one example, the data is retimed to four times the data rate of each sensor bus and data from four different cores is combined onto a single bus that carries all of the data from all four cores. In another example, the data is provided on four parallel buses, one for each core.

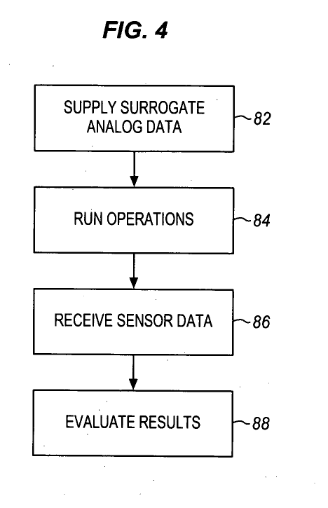

FIG. 4 shows a debugging process using the test equipment setup shown in FIGS. 1, 2, and 3. In FIG. 4, an IC has been fabricated with a common sensor bus to report analog sensor data in a digital form on a single bus as shown in FIGS. 1, 2, and 3. Alternatively, several different buses may be used to carry the sensor data to a test tool. The bus also includes consumers to set specified components in the IC to particular states.

The test cycle begins at block 82 as surrogate analog data is supplied to the common bus. This data is sent to the designated consumers that may then configure the IC as desired. The analog data may be generated in a logic simulation engine 8 or other device. Knowing the configuration of any relevant registers, pins, signal lines or other components on the bus provides much greater certainty in the test. Alternatively, the configuration of the device may be set using conventional set-up routines.

At block 84, the operations to be tested are run from the established initial conditions of block 82. The operations may be any type of operations that are to be tested in any aspect of device operation from initiation, setup, and configuration, to normal operations, to special modes, to shut down.

At block 86, sensor data is received. This may be performed during operation of the IC as well as after the operations have been terminated or shut down. The sensor data may be any analog or digital data that is carried by the bus. The sensor data is received from the external bus control unit, analyzed by the logic analyzer and collected in the trace collection unit to a format that may be operated on in the test tools and any other tools.

At block 88, the collected trace reflecting the test results are evaluated. The trace may be compared to traces collected from other IC's or compared to a predicted trace from a logic simulation engine 8. Further study by design or process engineers may be made and additional tests may be devised based on the trace to characterize the behavior of the IC more accurately. If the operations of FIG. 4 are performed in a production environment, then the IC may be graded or inventoried or discarded based on its performance.

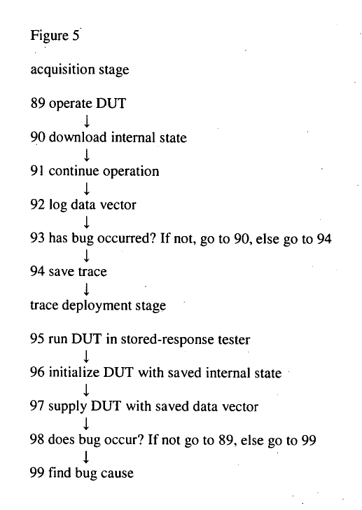

FIG. 5 shows another debugging process using the test equipment setup shown in FIGS. 1, 2, and 3. The hardware configuration for FIG. 5 may be similar to that of FIG. 4.

The test cycle of FIG. 5 begins with a trace acquisition phase, which includes blocks 89-94. The acquisition phase begins at block 89 with the DUT operating in a typical system environment. During operation internal state data is acquired periodically using the common sensor bus at block 90. This may be done by interrupting normal operation or by collecting data directly through e.g. the debug port. The collected data is downloaded to a trace collection device.

The DUT operation is continued for some selected amount of time at block 91 and after that time has elapsed, the most recent data vector is logged at block 92. This data vector may include all of the inputs, detected on the pins of the DUT or detected from the devices coupled to the DUT as well as the times of those inputs. It may also include all of the digitized analog sensor date collected on the common sensor bus and the times of those outputs. The time interval for this data vector may be selected based on the particular acquisition desired. In one embodiment, the time interval is only the time between the internal state download at block 90 and the end of the fixed time period of block 91.

At block 93 if a bus has occurred, then at block 94, the most recent trace may be stored in a database. The trace may include the internal state collected at block 90 and the data vector from block 92. It may also include other information and be associated with a particular test cycle and environmental, process, and hardware information. If no bug has occurred, then the acquisition phase may return to block 90, so the internal state is downloaded and the DUT is operated for another period of time.

The test cycle may continue with a trace deployment phase that includes blocks 95-99. At block 95, the saved trace is run on a DUT in a stored-response tester rather than in the typical system environment. The DUT is first initialized at block 96 with the saved internal state collected at block 94. The tester may then supply the saved data vector collected at block 94 to the DUT at block 97. At block 98, if the bug is successfully demonstrated, then debug will proceed at block 99 using existing debug tools on the stored-response tester. This may result in quickly finding the root cause of the bug and the bug may then be corrected. On the other hand, if the bug does not occur, then the acquisition phase may be repeated to obtain a better trace.

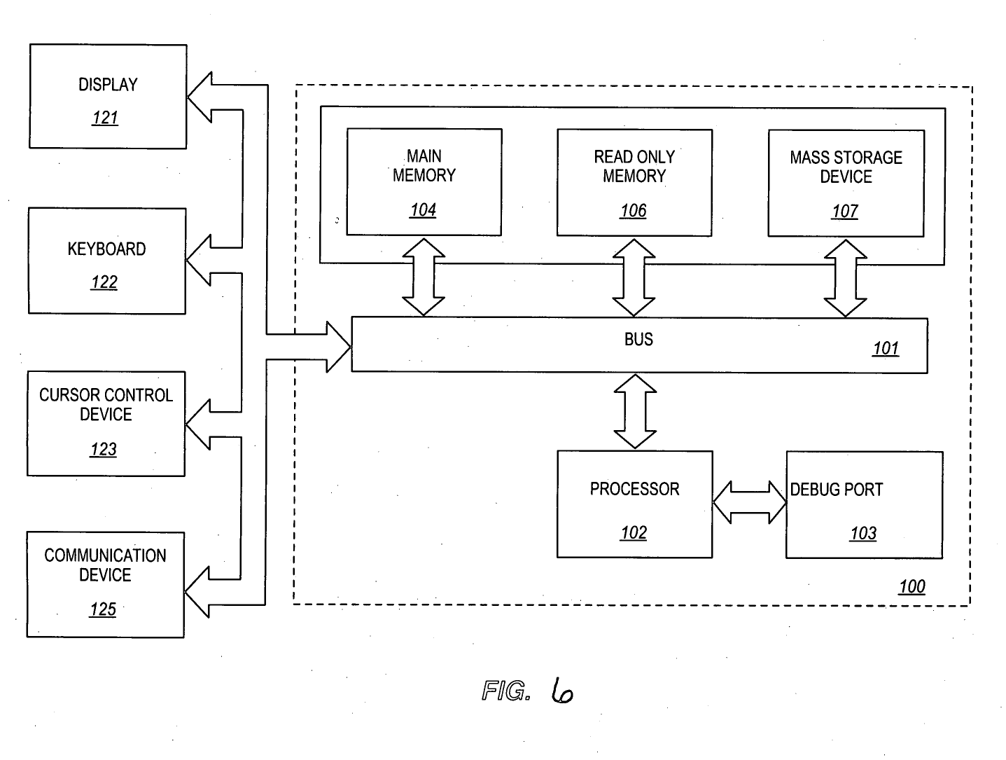

A computer system 100 representing an example of a system upon which features of the present invention may be implemented is shown in FIG. 6. The test tool, the logic simulation engine and the test unit may be operated on this architecture. In addition, the DUT may be installed in this architecture for test and the DUT after test may be place in a run-time environment for normal operations in this environment. The computer system 100 includes a bus or other communication means 101 for communicating information, and a processing means such as a microprocessor 102 coupled with the bus 101 for processing information. For testing the microprocessor as the DUT, a debug port 103 is coupled to the microprocessor separate from the system bus to allow independent access by the external test tool. The debug port may be a part of the microprocessor or a separate device. It may be deactivated and removed after the tests are complete.

The computer system 100 further includes a main memory 104, such as a random access memory (RAM) or other dynamic data storage device, coupled to the bus 101 for storing information and instructions to be executed by the processor 102. The main memory also may be used for storing temporary variables or other intermediate information during execution of instructions by the processor.

The computer system may also include a nonvolatile memory 106, such as a read only memory (ROM) or other static data storage device coupled to the bus for storing static information and instructions for the processor. A mass memory 107 such as a magnetic disk or optical disc and its corresponding drive may also be coupled to the bus of the computer system for storing information and instructions.

The computer system can also be coupled via the bus to a display device or monitor 121, such as a Liquid Crystal Display (LCD), for displaying information to a user. For example, graphical and textual indications of installation status, operations status and other information may be presented to the user on the display device. Typically, an alphanumeric input device 122, such as a keyboard with alphanumeric, function and other keys, may be coupled to the bus for communicating information and command selections to the processor. A cursor control input device 123, such as a mouse, a trackball, or cursor direction keys can be coupled to the bus for communicating direction information and command selections to the processor and to control cursor movement on the display 121.

A communication device 125 is also coupled to the bus 101. The communication device 125 may include a modem, a network interface card, or other well known interface devices, such as those used for coupling to Ethernet, token ring, or other types of physical attachment for purposes of providing a communication link to support a local or wide area network (LAN or WAN), for example. In this manner, the computer system may also be coupled to a number of clients or servers via a conventional network infrastructure, including an intranet or the Internet, for example.

It is to be appreciated that a lesser or more equipped computer system than the example described above may be preferred for certain implementations. Therefore, the configuration of the exemplary computer system 100 will vary from implementation to implementation depending upon numerous factors, such as price constraints, performance requirements, technological improvements, or other circumstances.

A lesser or more complicated analog sensor bus, communications bus, external bus controller, digitizer, time scheduler or test configuration may be used than those shown and described herein. Therefore, the configurations may vary from implementation to implementation depending upon numerous factors, such as price constraints, performance requirements, technological improvements, or other circumstances. Embodiments of the invention may also be applied to other types of systems that use different inputs and outputs than those shown and described herein.

Embodiments of the present invention may be provided as a microcode, firmware, embedded instructions, or a computer program product which may include a machine-readable medium having stored thereon instructions which may be used to program a general purpose processor, embedded processor or application specific device (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

What is claimed is:

1. An integrated circuit comprising
a plurality of analog sensors to generate an analog output in response to a respective event on the integrated circuit;
a plurality of digitizers each coupled to an analog sensor to generate a digital representation of the analog output of the respective sensor; and
a communications bus coupled to the plurality of digitizers to communicate the digital representations to an external device.

2. The integrated circuit of claim 1, wherein the digitizers each transmit the respective digital representation to the communications bus at an assigned time.

3. The integrated circuit of claim 1, wherein the analog sensors generate the respective analog output at a respective assigned time.

4. The integrated circuit of claim 1, wherein the integrated circuit comprises a plurality of processing cores, and wherein the communications bus comprises a feed bus for each core and an output bus to receive the digital representations for each feed bus and communicate the combined digital representations to an external device.

5. The integrated circuit of claim 1, wherein the communications bus comprises a plurality of OR circuits coupled between each digitizer and the bus to apply the digital representation from the respective digitizer when there is no other digital representation on the bus.

6. The integrated circuit of claim 1, further comprising a bus control unit coupled to the bus to receive the digital representations and convert them to a pin signaling protocol.

7. The integrated circuit of claim 1, wherein at least one analog sensor comprises a temperature sensor.

8. The integrated circuit of claim 1, wherein at least one analog sensor comprises a lock indication signal for a phase locked loop.

9. The integrated circuit of claim 1, wherein at least one analog sensor comprises a power status indicator.

10. The integrated circuit of claim 1, further comprising a plurality of consumers coupled to the bus, the consumers receiving a digital value on the bus and applying the digital value to a register in place of a sensed value.

11. The integrated circuit of claim 10, wherein the register comprises a temperature sensor register.

12. The integrated circuit of claim 1, wherein the communications is bidirectional to apply an external input data to the integrated circuit.

13. The integrated circuit of claim 12, wherein the external input data replaces an output of at least one of the plurality of analog sensors that is used internally by the integrated circuit.

14. A computer system comprising:
a microprocessor;
a socket interface on the microprocessor;
a plurality of analog sensors on the microprocessor to generate an analog output in response to a respective event on the integrated circuit;
a plurality of digitizers on the microprocessor each coupled to an analog sensor to generate a digital representation of the analog output of the respective sensor;
a communications bus on the microprocessor coupled to the plurality of digitizers;
a motherboard having a socket to receive the socket interface; and
a communications port on the motherboard to connect to the communications bus through the socket interface.

15. The computer system of claim 14, further comprising a power supply on the motherboard to supply power to the microprocessor based on digital representations received on the communications port.

16. The computer system of claim 14, further comprising a plurality of time slot synchronizers on the microprocessor, each coupled to a digitizer to time the application of the respective digital representation on the communications bus.

17. A method comprising:
sensing analog data at a plurality of locations in an integrated circuit;
digitizing the sensed analog data;
applying the digitized analog data from each of the plurality of locations to a common sensor bus, the data from each location being applied to the bus at a different time.

18. The method of claim 17, further comprising:
applying data to the common sensor bus from an external source;
receiving the applied data at a plurality of consumers in the integrated circuit at a predefined time for each consumer; and
applying the received data at each consumer as if the data were sensed by a corresponding analog sensor.

19. The method of claim 18 wherein the data from the external source comprises data corresponding to simulations of sensed analog data.

20. The method of claim 19, further comprising applying the received data to a logic simulator during a test to test internal functions of the integrated circuit.
